(19) United States
(12) Patent Application Publication
(10) Pub. No.: US 2015/0198443 A1
(43) Pub. Date: Jul. 16, 2015

(54) LOCALIZATION ACTIVITY CLASSIFICATION SYSTEMS AND METHODS

(71) Applicant: Alcatel-Lucent USA Inc., Murray Hill, NJ (US)

(72) Inventors: Saehoon Yi, Piscataway, NJ (US); Piotr Mirowski, New York, NY (US); Tin Ho, Millburn, NJ (US)

(73) Assignee: Alcatel-Lucent USA Inc., Murray Hill, NJ (US)

(21) Appl. No.: 14/152,209

(22) Filed: Jan. 10, 2014

(51) Int. Cl. G01C 5/06; G01P 15/14; G06N 99/00; G01C 19/00

(52) U.S. Cl. CPC G01C 5/06; G01C 19/00; G01P 15/14; G06N 99/005

(57) ABSTRACT

A system and method for providing multi-floor activity classification for a mobile device within a multi-floor environment includes an activity recognition module receiving inertial readings and pressure readings from the mobile device. The activity recognition module classifies activities for the mobile device from the inertial readings and the pressure readings.

### FIELD OF THE INVENTION

The present invention relates to localization and mapping.

### BACKGROUND OF THE INVENTION

There is an increasing need to provide localization and mapping in environments where global positioning systems (GPS) cannot be reliably used, such as in indoor environments where GPS signals are not typically able to register. Localization and mapping of these indoor environments is desirable for location-based services, targeted advertising, network deployment optimization for pervasive computing and the like. However, known localization and mapping systems for GPS-deprived environments lack accuracy or require too resource-intensive computations and/or specialized hardware to be widely employed.

### SUMMARY

According to an embodiment, a system for providing multi-floor activity classification for a mobile device within a multi-floor environment includes an activity recognition module receiving inertial readings from an inertial measurement unit of the mobile device and pressure readings from a barometer. The activity recognition module classifies activities for the mobile device from the inertial readings and the pressure readings.

According to an embodiment, the inertial readings include acceleration readings from an accelerometer and gyroscopic readings from a gyroscope.

According to an embodiment, the activity recognition module includes a feature extractor that extracts pose invariant features from the accelerometer and gyroscope readings, the activity classification being based on the pose invariant features.

According to an embodiment, the pose invariant features are represented by a vector of features from an autocorrelation matrix of the accelerometer and gyroscope readings.

According to an embodiment, the feature extractor extracts statistical data from the pressure readings, the activity classification being based on the statistical data.

According to an embodiment, the system also includes a post-processing module receiving the activity classifications from the activity recognition module and the pressure readings from a barometer of the mobile device. The post-processing module determines an activity label and floor label for the mobile device based on the activity classifications and the pressure readings.

According to an embodiment, the post-processing module includes a Hidden Markov Model.

According to an embodiment, the system also includes a geolocalization system including known locations for at least one of a staircase, an elevator or an escalator within the multi-floor environment. The geolocalization system is adapted to locate the mobile device within the multi-floor environment based on the known locations and activity labels including at least one of taking stairs, elevators or escalators.

According to an embodiment, the geolocalization system is adapted to reconstruct a trajectory for the mobile device within the multi-floor environment based on the activity label, the floor label and position estimates from the inertial measurement unit of the mobile device.

According to an embodiment, the geolocalization system includes pre-defined activities indicative of known locations within the multi-floor environment. The geolocalization system is adapted to locate the mobile device within the multi-floor environment based on the known locations when the pre-defined activities are detected from the activity labels.

According to an embodiment, a computerized localization method includes receiving, at an activity recognition module executing on a processor, inertial readings from an inertial measurement unit of a mobile device and pressure readings from a barometer. The computerized method further includes classifying, by the activity recognition module executing on the processor, activities for the mobile device from the inertial readings and the pressure readings.

According to an embodiment, the inertial readings include acceleration readings from an accelerometer and gyroscopic readings from a gyroscope.

According to an embodiment, the computerized method additionally includes extracting, by a feature extractor of the activity recognition module, pose invariant features from the accelerometer and gyroscope readings, and classifying the activities based on the pose invariant features.

According to an embodiment, extracting the pose invariant features includes determining a vector of features from an autocorrelation matrix of the accelerometer and gyroscope readings.

According to an embodiment, the computerized method additionally includes extracting, by the feature extractor of the activity recognition module, statistical data from the pressure readings, and classifying the activities based on the statistical data.

According to an embodiment, the computerized method additionally includes post-processing, by a post-processing module executing on the processor, the activity classifications from the activity recognition module and the pressure readings from the barometer in a Hidden Markov Model to determine an activity label and a floor label for the mobile device based on the activity classifications and the pressure readings.

According to an embodiment, a non-transitory, tangible computer-readable medium storing instructions adapted to be executed by at least one processor of a mobile device to perform a method may comprise the steps of receiving, at an activity recognition module executing on the at least one processor, inertial readings from an inertial measurement unit of a mobile device and pressure readings from a barometer, and classifying, by the activity recognition module executing on the at least one processor, activities for the mobile device from the inertial readings and the pressure readings.

According to an embodiment, the method may also include extracting, by a feature extractor of the activity recognition module, pose invariant features from the inertial readings, and classifying the activities based on the pose invariant features.

According to an embodiment, the method may additionally include extracting, by the feature extractor of the activity recognition module, statistical data from the pressure readings, and classifying the activities based on the statistical data.

According to an embodiment, the method may additionally include post-processing, by a post-processing module executing on the at least one processor, the activity classifications from the activity recognition module and the pressure readings from the barometer in a Hidden Markov Model to determine an activity label and a floor label for the mobile device based on the activity classifications and the pressure readings.

These and other embodiments will become apparent in light of the following detailed description herein, with reference to the accompanying drawings.

### BRIEF DESCRIPTION OF THE DRAWINGS

FIG. 1 is a schematic diagram of a system according to an embodiment;

FIG. 2 is flow diagram of an embodiment for providing localization activity classification with the system of FIG. 1;

FIG. 3 is a schematic diagram of an embodiment of a Hidden Markov Model of the system of FIG. 1;

FIG. 4 is a graphical representation of activity classifications from the system of FIG. 1 according to an embodiment;

FIG. 5 is a schematic diagram incorporating the activity classifications generated by the system of FIG. 1 as landmarks in a geolocalization system;

FIG. 6 is a graphical representation of geolocalization with the activity classifications from the system of FIG. 1 according to an embodiment; and

FIG. 7 is a flow diagram of a geolocalization system incorporating the system of FIG. 1 according to an embodiment.

### DETAILED DESCRIPTION

Before the various embodiments are described in further detail, it is to be understood that the invention is not limited to the particular embodiments described. It will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

In the drawings, like reference numerals refer to like features of the systems and methods of the present application. Accordingly, although certain descriptions may refer only to certain Figures and reference numerals, it should be understood that such descriptions might be equally applicable to like reference numerals in other Figures.

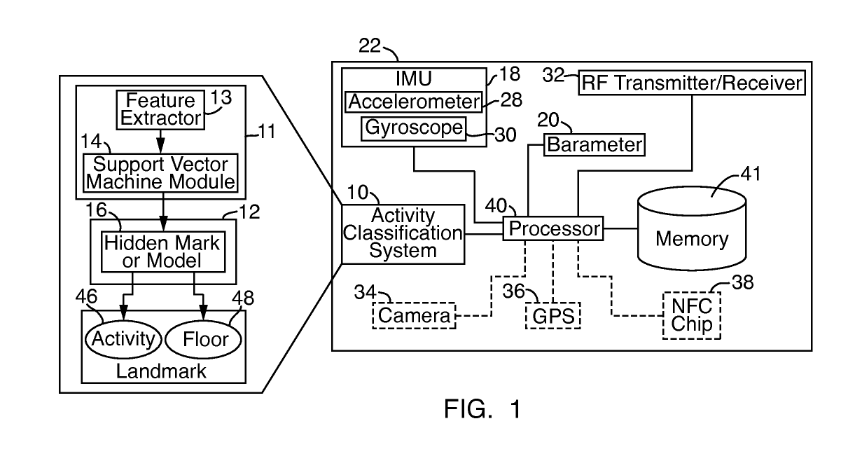

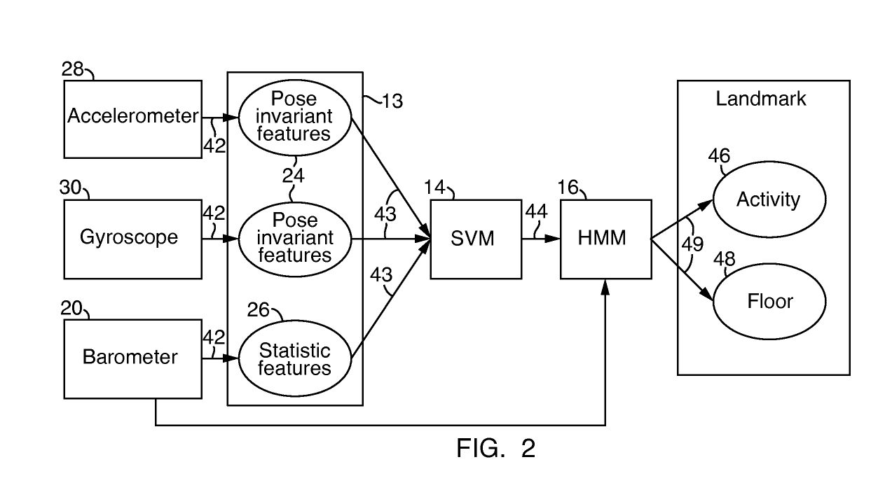

Referring to FIG. 1, a system 10 for localization activity classification is shown. The system 10 includes an activity recognition module 11 and a post-processing module 12. The activity recognition module 11 includes a feature extractor 13 and a Support Vector Machine module 14. The post-processing module 12 includes a Hidden Markov Model 16. The Support Vector Machine module 14 is in communication with the feature extractor 13 and the Hidden Markov Model 16 is in communication with the Support Vector Machine module 14. The feature extractor 13 is operatively connected to an inertial measurement unit (IMU) 18 and a barometer 20 of a mobile device 22 for extracting pose-invariant features 24, shown in FIG. 2, and statistic features 26, shown in FIG. 2, respectively, therefrom. The IMU 18 may include all of the inertial sensors available on a modern smart phone including a three-axis accelerometer 28 and a three-axis gyroscope 30, thereby allowing the IMU 18 to track three-dimensional motion at high frequency. The system 10 provides for robust and pose-invariant detection of pedestrian activity (such as walking, taking stairs, taking elevators, etc.) and floor identification using the inertial and the barometric data acquired on the mobile device 22 being worn or carried by a pedestrian in an indoor environment and, more particularly, in a multi-floor indoor environment.

As should be understood by those skilled in the art, the mobile device 22 may also include one or more radio frequency (“RF”) transmitters/receivers 32 available on modern smart phones for sending/receiving RF transmissions including WiFi, 4G Long Term Evolution (LTE) and/or Bluetooth transmissions and may include one or more of a camera 34, global positioning system (GPS) 36 and/or near field communication (NFC) chip 38, all of which are available on modern smart phones. These additional features may be used in conjunction with the system 10 to provide pose-invariant multi-floor localization and for the reconstruction of indoor radio frequency signal maps, as discussed below.

The system 10 includes the necessary electronics, software, memory, storage, databases, firmware, logic/state machines, microprocessors, communication links, and any other input/output interfaces to perform the functions described herein and/or to achieve the results described herein. For example, the system 10 may include one or more processors 40 and memory 41, which may include system memory, including random access memory (RAM) and read-only memory (ROM). Suitable computer program code may be provided to the system 10 for executing numerous functions, including those discussed in connection with the feature extractor 13, Support Vector Machine module 14 and Hidden Markov Model 16.

For example, in embodiments, feature extractor 13 and the Support Vector Machine module 14 may be stored in memory 41 on the mobile device 22 and may be executed by at least one processor 40 of the mobile device 22, while the Hidden Markov Model 16 may be stored on and executed by a remote computing device, such as a server in communication with the mobile device 22 over a network, as should be understood by those skilled in the art. In embodiments, the feature extractor 13, Support Vector Machine module 14 and Hidden Markov Model 16 may all be stored in memory 41 on the mobile device 22 and may be executed by the at least one processor 40 of the mobile device 22. In yet further embodiments, both the Support Vector Machine module 14 and the Hidden Markov Model 16 may be stored on and executed by one or more remote computing devices in communication with the mobile device 22, as should be understood by those skilled in the art.

The one or more processors 40 may include one or more conventional microprocessors and one or more supplementary co-processors such as math co-processors or the like. The one or more processors 40 may communicate with other networks and/or devices such as servers, other processors, computers, smart phones, cellular telephones, tablets and the like.

The one or more processors 40 may be in communication with memory 41, which may comprise an appropriate combination of magnetic, optical and/or semiconductor memory, and may include, for example, RAM, ROM, flash drive, an optical disc such as a compact disc and/or a hard disk or drive. The one or more processors 40 and the memory 41 may be, for example, located entirely within a single computer or other device; or connected to each other by a communication medium, such as a USB port, serial port cable, a coaxial cable, an Ethernet type cable, a telephone line, a radio frequency transceiver or other similar wireless or wired medium or combination of the foregoing.

The memory 41 may store inertial measurements taken by the IMU 18 and any other information required by the feature extractor 13, Support Vector Machine module 14 and/or the Hidden Markov Model 16, an operating system, such as for the mobile device 22, and/or one or more other programs (e.g., computer program code and/or a computer program product) adapted to direct the feature extractor 13, Support Vector Machine module 14 and Hidden Markov Model 16 to perform according to the various embodiments discussed herein. The feature extractor 13, Support Vector Machine module 14, Hidden Markov Model 16 and/or other programs discussed herein may be stored, for example, in a compressed, an uncompiled and/or an encrypted format, and may include computer program code executable by the one or more processors 40. The instructions of the computer program code may be read into a main memory of the one or more processors 40 from the memory 41 or a computer-readable medium other than the memory 41. While execution of sequences of instructions in the program causes the one or more processors 40 to perform the process steps described herein, hard-wired circuitry may be used in place of, or in combination with, software instructions for implementation of the processes of the present invention. Thus, embodiments of the present invention are not limited to any specific combination of hardware and software.

The methods and programs discussed herein may also be implemented in programmable hardware devices such as field programmable gate arrays, programmable array logic, programmable logic devices or the like. Programs may also be implemented in software for execution by various types of computer processors. A program of executable code may, for instance, comprise one or more physical or logical blocks of computer instructions, which may, for instance, be organized as an object, procedure, process or function. Nevertheless, the executables of an identified program need not be physically located together, but may comprise separate instructions stored in different locations which, when joined logically together, comprise the program and achieve the stated purpose for the programs such as providing localization activity recognition. In an embodiment, an application of executable code may be a compilation of many instructions, and may even be distributed over several different code partitions or segments, among different programs, and across several devices.

The term “computer-readable medium” as used herein refers to any medium that provides or participates in providing instructions and/or data to the one or more processors of the system 10 (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the one or more processors (or any other processor of a device described herein) for execution. For example, the instructions may initially be stored on a magnetic disk of a remote computer (not shown). The remote computer can load the instructions into its dynamic memory and send the instructions over an Ethernet connection, cable line, telephone line using a modem, wirelessly or over another suitable connection. A communications device local to a computing device can receive the data on the respective communications line and place the data on a system bus for the one or more processors. The system bus carries the data to the main memory, from which the one or more processors 40 retrieve and execute the instructions. The instructions received by main memory may optionally be stored in memory 41 either before or after execution by the one or more processors 40. In addition, instructions may be received via a communication port as electrical, electromagnetic or optical signals, which are exemplary forms of wireless communications or data streams that carry various types of information.

Referring to FIG. 2, in operation, the system 10 collects time-stamped data from the accelerometer 28, gyroscope 30 and barometer 20 of the mobile device 22, shown in FIG. 1, at 42. The feature extractor 13 extracts the pose-invariant features 24 from the correlation spectrum of the raw accelerometer 28 and gyroscope 30 readings. The pose-invariant features 24 may be extracted, for example, at a constant sampling rate (e.g., at 50 Hz). Data from both the accelerometer 28 and gyroscope 30 is represented as a three dimensional (“3D”) time series of accelerations with respect to x, y, and z axes aligned with the mobile device 22. As a result, such sensor readings typically depend on the pose or orientation of the mobile device 22, such as the orientation of the mobile device 22 in a pedestrian's pocket. The feature extractor 13 advantageously extracts pose-invariant features 24 from the raw data from the accelerometer 28 and gyroscope 30 so that the pedestrian is not restricted to keeping the mobile device 22 in a particular orientation or position while the features are extracted. In other words, extracting pose-invariant features 24 as described herein means extracting quantitative descriptors that have the same (or substantially same or similar) values regardless of the direction or orientation of the mobile device when the values are calculated and without limiting the orientation or position of the mobile device to any particular configuration.

To extract the pose-invariant features 24, the feature extractor 13 uses a subset s(t) of the raw data from the accelerometer 28 and gyroscope 30. For example, the feature extractor 13 may use data for a predetermined number of time points (e.g. 64 time points 0.02 seconds apart) and may use a sliding window for every time data is collected (e.g. a sliding window of step size 15 time points). The feature extractor 13 then calculates the autocorrelation matrix A in the frequency domain for the subset s(t) using the following equations:

f(ω)=∫exp(−iωt)s(t)dtεC³, (1)

F=[f(ω₁),f(ω₂), . . . ,f(ωₙ)]εC^{3×n}, (2)

A=F*F. (3)

Specifically, equation (1) converts the subset s(t) to the frequency domain. Signal f(ω) is calculated by Fast Fourier transform on s(t) using equation (1). Autocorrelation matrix A, in the frequency domain, is acquired in equation (3) by multiplying conjugate transpose of the Fourier transformed signal F. The autocorrelation matrix A provides a pose invariant property from the raw acceleration and gyroscope data and is a n×n symmetric matrix where n is the number of frequencies. Since the autocorrelation matrix A is symmetric, the feature extractor 13 uses only the upper triangle of the autocorrelation matrix A to provide the pose invariant features 24 as a vector of pose invariant features.

The feature extractor 13 also extracts the statistical data 26 from the barometer 20 in each sliding window of time points. For example, the statistical features may include:

TABLE 1
Statistical features for barometer data.

| | |
|---|---|
| Relative to initial point | b̅(t) = b(t) − b(1) |
| Velocity | v(t) = b(t) − b(t − 1) |
| Acceleration | a(t) = v(t) − v(t − 1) |
| Mean | ${μ}_{1} = \frac{1}{n} {\sum }_{t = 1}^{n} \overline{b} ( t )$ |
| Mean of 1^{st} half | ${μ}_{1} = \frac{2}{n / 2} {\sum }_{t = 1}^{n} \overline{b} ( t )$ |
| Mean of 2^{nd} half | ${μ}_{2} = \frac{2}{n} {\sum }_{t = n / 2 + 1}^{n} \overline{b} ( t )$ |
| Difference of means | μ₃ = μ₂ − μ₁ |
| Slope | θ = b(n) − b(1) |
| Variance | ${σ}^{2} = \frac{1}{n} {\sum }_{t = 1}^{n} {( \overline{b} ( t ) - μ )}^{2}$ |
| Standard deviation | σ = {square root over (()}σ²) |
| Root mean square | $r = \sqrt{(} \frac{1}{n} {\sum }_{t = 1}^{n} {\overline{b} ( t )}^{2} )$ |
| Signal magnitude area | $s = \frac{1}{n} {\sum }_{t = 1}^{n} \vert \overline{b} ( t ) \vert$ |

where b(t) is the measured barometric pressure at a given time point t. The statistical data 26 provides for more robust observations than observations based on the raw barometric pressure data alone since the barometer readings typically fluctuate, even when the barometer 20 remains in the same position.

The activity recognition module 11, shown in FIG. 1, provides the vector of pose invariant features 24 and the statistical data 26 from the feature extractor 13 to the Support Vector Machine module 14 at 43. The Support Vector Machine module 14 classifies an activity for the sliding window subset s(t) corresponding to the vector of pose invariant features 24 and the statistical data 26. The activity classification may include, for example, the six activity classes of not moving, walking, taking an elevator or escalator up, taking an elevator or escalator down, taking stairs up, and taking stairs down. The Support Vector Machine module 14 is trained using training data for the different activities so that the Support Vector Machine module 14 is able to distinguish between the different activities based on the vector of pose invariant features 24 and the statistical data 26. For locomotive activities, such as walking and taking stairs, the inertial data provided by the vector of pose invariant features 24 may be sufficient for the Support Vector Machine module 14 to classify an activity. For example, the activity of walking may have a different correlation pattern as compared to the activity of taking stairs. For other activities, such as not moving and taking an elevator, the activity recognition module 11 may observe an approximate acceleration of zero from the IMU 18, shown in FIG. 1, and, therefore, the Support Vector Machine module 14 may primarily use the statistical data 26 from the barometer 20 for activity identification. For example, if the pedestrian is not moving, the statistical data 26 should indicate that air pressure remains substantially unchanged. Conversely, the statistical data 26 may indicate that the air pressure is changing if the pedestrian is taking the elevator up or down. Barometric features from the statistical data 26 such as the difference of the two mean values from the first and second half of the sliding window may allow the Support Vector Machine module 14 to identify these pressure differences. Thus, the Support Vector Machine module 14 classifies a given sliding window subset s(t) as a particular activity. Additionally, the Support Vector Machine module 14 may also generate a class probability estimate p(s_{act}_{ᵢ}|y_{act}), for example, using Platt's scaling algorithm, as should be understood by those skilled in the art.

Although described in connection with the exemplary activities above for simplicity, it should be understood by those skilled in the art that additional activities recognizable from inertial and barometric data, that are either naturally occurring or specially designed, may be added to the list of activities identifiable by the Support Vector Machine module 14.

The activity classification decision of the Support Vector Machine module 14 is provided to the Hidden Markov Model 16 of the post-processing module 12, shown in FIG. 1, at 44, which uses the input from the Support Vector Machine module 14 to improve the activity recognition result and to provide floor identification and outputs an activity label 46 and floor label 48 for the pedestrian at 49.

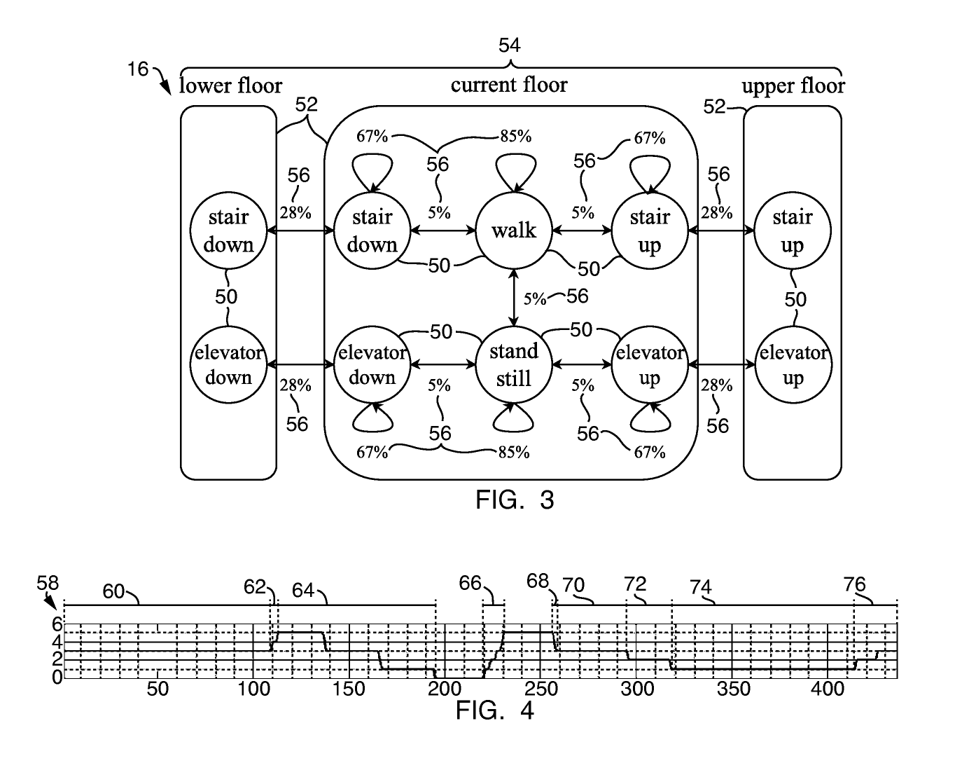

Referring to FIG. 3, to improve the activity recognition result and to provide the floor identification the Hidden Markov Model 16 defines states 50 as the activity classes in each floor 52 of a multi-floor environment 54. The Hidden Markov Model 16 is constructed to have state transition probabilities 56 that are higher for staying in the same state 50 and lower for transitioning to other states 50 of feasible state transitions. The transition probabilities may be learned from training data, selected from common knowledge, or the like. For example, since activity transitions occur sparsely over time, the probability of a state transition may be set to be much lower than the probability of staying in the same state 50. Additionally, transitions between certain activities may not be possible, as seen in the Hidden Markov Model 16. For example, between an elevator activity and walking, the pedestrian must stand still for a short period of time.

The Hidden Markov Model 16 takes a sequence of activity class probability estimates p(s_{act}_{ᵢ}|y_{act}) from the Support Vector Machine module 14 and floor likelihood p(s_{floor}_{ᵢ}|y_{floor}) from the Gaussian distribution of barometer data and determines observation probabilities p(y|sᵢ) jointly from activity and floor likelihood using the equations:

$$\begin{matrix}p ( y \vert {s}_{i} ) = \frac{p ( {s}_{i} \vert y ) p ( y )}{p ( {s}_{i} )} , & ( 4 ) \\ p ( {s}_{i} \vert y ) = p ( {s}_{{floor}_{i}} \vert {y}_{floor} ) p ( {s}_{{act}_{i}} \vert {y}_{act} ) , & ( 5 ) \\ p ( y ) = \frac{1}{\vert T \vert} , p ( {s}_{i} ) = \frac{1}{\vert S \vert} . & ( 6 )\end{matrix}$$

### Where,

p(s_{act}_{ᵢ}|y_{act}) is the class probability estimate generated by the Support Vector Machine module 14;

p(s_{floor}_{ᵢ}|y_{floor}) is the Gaussian distribution likelihood on each floor from barometer observation, which may be estimated since air pressure decreases linearly for higher floors;

T is the length of the sequence; and

S is the number of states (e.g. the number of possible activities multiplied by the number of floors).

Once the observation probabilities p(y|sᵢ) are calculated, the post-processing module 12, shown in FIG. 1, infers the most probable state sequence using the Viterbi algorithm, as should be understood by those skilled in the art. The Viterbi algorithm infers the most probable state 50 of the given Hidden Markov Model 16 and, since the states 50 consist of activities and floors, the time-stamped activities of taking stairs and elevators with corresponding floor information may be obtained from Viterbi state sequences. Since the Support Vector Machine module 14, shown in FIG. 2, may have misclassified one or more of the activity classifications in the sequence input to the Hidden Markov Model 16, the Hidden Markov Model 16 calculates all possible probabilities and then chooses the most likely state 50. Thus, the Hidden Markov Model 16 ensures that state transitions only occur if the observation probability p(y|sᵢ) is high enough by smoothing out noisy activity classifications from the Support Vector Machine module 14, shown in FIG. 2.

Referring back to FIG. 2, as discussed above, at 49, the Hidden Markov Model 16 outputs the activity label 46 and floor label 48 based on the most likely state calculation. Thus, the Hidden Markov Model 16 jointly infers the activity with floor information of a pedestrian such that the system 10, shown in FIG. 1, may determine if the pedestrian is standing still, walking, taking stairs, elevators and/or escalators in specific floors.

For instance, referring to FIG. 4, in an exemplary embodiment, as the pedestrian moves in a multi-floor building having six floors 58, the system 10, shown in FIG. 1, may detect that the pedestrian is walking on a third floor at 60. At 62, the system 10, shown in FIG. 1, detects that the pedestrian is taking the elevator up from the third floor to the fifth floor. At 64, the system 10, shown in FIG. 1, detects that the pedestrian is taking the elevator down from the fifth floor to the basement floor, while stopping at the third and first floors. The system 10, shown in FIG. 1, then detects that the pedestrian is taking the elevator up from the basement floor to the fifth floor at 66 and taking the elevator back down to the third floor at 68. The system 10, shown in FIG. 1, then detects walking on the third floor at 70 and that the pedestrian is taking the stairs from the third floor to the first floor at 72. The system 10, shown in FIG. 1, then detects that the pedestrian is walking on the first floor at 74 and taking the stairs back to the third floor at 76. Accordingly, the system 10, shown in FIG. 1, may accurately track the pedestrian's activities in the multi-floor building.

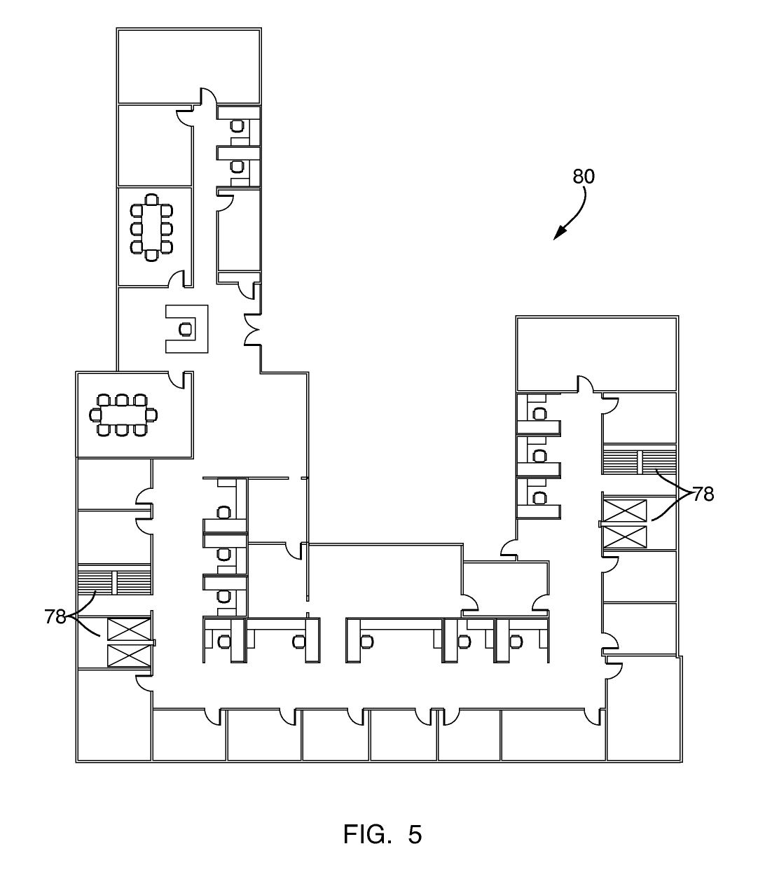

Referring to FIG. 5, the activity and floor information output by the Hidden Markov Model 16, shown in FIG. 2, of the post-processing module 12, shown in FIG. 1, may be represented as landmarks 78 to provide reference points in geolocalization systems and, more specifically, indoor geolocalization systems where GPS signals are not typically able to register. For example, the system 10, shown in FIG. 1, and the activity labels 46 and floor labels 48, shown in FIG. 2, generated by the Hidden Markov Model 16 may be used in conjunction with known geolocalization systems, such as that described in U.S. patent application Ser. No. 14/063,735, filed on Oct. 25, 2013, which is hereby incorporated herein by reference in its entirety, to provide organic landmarks 78 in the form of the floor, staircase and/or elevator information to allow the geolocalization systems to recover the precise location and trajectory of the pedestrian in the environment of concern. For example, since the actual location of staircases and elevators may be known from building blueprints 80, maps and the like, the geolocalization systems may be able to fix the pedestrian's calculated location to the actual location of the landmark 78, such as a particular staircase or elevator, when the system 10, shown in FIG. 1, classifies the pedestrian's activity as using stairs or an elevator, respectively.

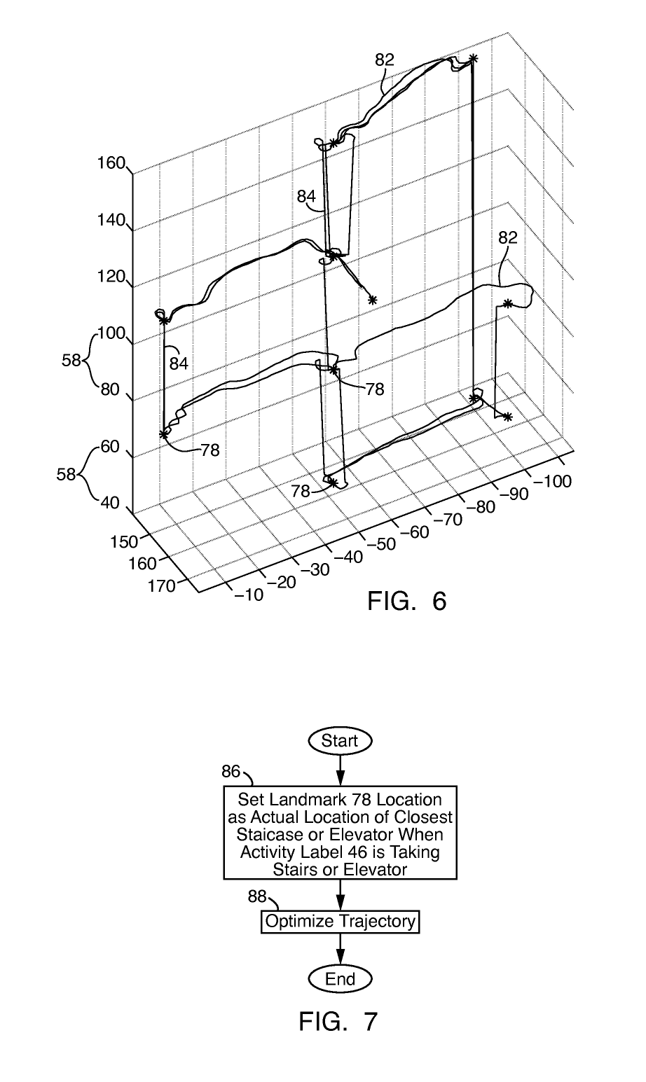

Referring to FIG. 6, the landmarks 78 and activity labels 46 and floor labels 48, shown in FIG. 2, generated by the system 10, shown in FIG. 1, may be used by the geolocalization system in conjunction with the history of the pedestrian's inertial data and pedestrian dead reckoning, to reconstruct the trajectory 82 of the pedestrian inside a multi-floor or multi-story environment since the system 10, shown in FIG. 1, is able to determine the floor information for the pedestrian. For example, the geolocalization system may reconstruct the pedestrian's trajectory 82 on each floor 58 of the multi-floor environment and may detect floor transitions 84 through the system 10, shown in FIG. 1.

Referring to FIG. 7, reconstructing the pedestrian's trajectory inside the multi-floor environment may include setting the landmark 78 location as the closest staircase or elevator on the current floor from the pedestrian's current location in the trajectory at step 86 when the pedestrian's activity label 46 is classified by the system 10, shown in FIG. 1, as taking stairs or elevators. At step 88, the pedestrian's trajectory is then optimized by the geolocalization system, such as the geolocalization system described in U.S. patent application Ser. No. 14/063,735, with the landmarks 78 provided in step 86, as should be understood by those skilled in the art. This optimization is performed until the trajectory converges, thereby reconstructing the pedestrian's trajectory inside the multi-floor environment.

The optimized trajectory may be used for a variety of purposes, such as to provide mapping of the environment of concern on the mobile device 22, shown in FIG. 1, by displaying the optimized trajectory on an image of the environment, which may be, for example, a satellite photograph, blueprint, or another similar image.

Thus, the system 10 advantageously provides the geolocalization system with organic landmarks 78 corresponding to staircases and elevators and provides floor identification, which allows the geolocalization system to precisely track the trajectory of pedestrians inside environments of concern, such as multi-story buildings, solely using the mobile device 22 and its various sensors with the mobile device 22 placed in the pedestrian's pocket. Accordingly, with the system 10, there is no need for the pedestrian to take the mobile device 22 out of the pocket to acquire additional landmark information from, for example, NFC tags or QR code that may provide information about specific locations in the environment. Alternatively, if there are insufficient organic landmarks 78 in the environment of concern, the system 10 may define landmarks as special gestures (such as stopping and walking following a pre-defined pattern) that are easily recognizable as activities by the system 10. These special gestures may be pre-defined and associated with specific points in the environment or building and, therefore, may serve as artificial landmarks 78 without the need to introduce another sensing system like the NFC tags or QR codes discussed above.

The system 10 may advantageously be implemented with geolocalization systems, as discussed above, to provide pedestrian tracking that requires no effort on the part of the pedestrian, since the mobile device 22 may be in any orientation and may remain in the pedestrian's pocket. This pedestrian tracking may advantageously be used for the reconstruction of indoor radio RF signal maps, as discussed in U.S. patent application Ser. No. 14/063,735, without prior knowledge of the sources of RF signals. Thus, the maps required for RF indoor localization may be constructed without any effort from the builder aside from walking in the environment of concern, simply by exploiting all of the sensor signals recorded on one or more mobile devices 22.

The system 10 for localization activity classification may advantageously be employed in indoor geolocalization products and services for institutions such as airports, shopping malls, museums, campuses, or the like to provide location services, advertisements, product recommendations, security-related services or other similar services inside buildings. The system 10 for localization activity classification may also be used for planning and optimization of the deployment of telecommunication networks such as LTE/4G small cells and the like.

The system 10 advantageously works entirely from the pocket with the mobile device 22 placed in any pose, unlike previous inventions that require mobile devices to be held in specific poses in specific locations. Thus, the system 10 simplifies data acquisition processes for RF map building. Additionally, the system 10 advantageously integrates activity detection with floor identification so that both activity and floor changes may be detected, thereby providing a more accurate and robust localization system.

Since the system 10 provides for pose-invariant activity detection, the system 10 advantageously allows the mobile device 22 to be placed in the pocket or the like of the pedestrian and does not require the mobile device 22 to be oriented or positioned in any particular manner (e.g., held vertically in the hand or the like).

Although this invention has been shown and described with respect to the detailed embodiments thereof, it will be understood by those skilled in the art that various changes in form and detail thereof may be made without departing from the spirit and the scope of the invention. For example, although the system 10, shown in FIG. 1, is described primarily in connection with providing activity classifications in indoor environments, the system 10 may provide activity classifications in a variety of environments, including outdoor environments or environments that include a combination of indoor and outdoor areas.

What is claimed is:

1. A system for providing multi-floor activity classification for a mobile device within a multi-floor environment, the system comprising:
an activity recognition module receiving inertial readings from an inertial measurement unit of the mobile device and pressure readings from a barometer, the activity recognition module classifying activities for the mobile device from the inertial readings and the pressure readings.

2. The system according to claim 1, wherein the inertial readings include acceleration readings from an accelerometer and gyroscopic readings from a gyroscope.

3. The system according to claim 2, wherein the activity recognition module includes a feature extractor that extracts pose invariant features from the accelerometer and gyroscope readings, the activity classification being based on the pose invariant features.

4. The system according to claim 3, wherein the pose invariant features are represented by a vector of features from an autocorrelation matrix of the accelerometer and gyroscope readings.

5. The system according to claim 3, wherein the feature extractor extracts statistical data from the pressure readings, the activity classification being based on the statistical data.

6. The system according to claim 1, additionally comprising:
a post-processing module receiving the activity classifications from the activity recognition module and the pressure readings from a barometer of the mobile device, the post-processing module determining an activity label and floor label for the mobile device based on the activity classifications and the pressure readings.

7. The system according to claim 6, wherein the post-processing module includes a Hidden Markov Model.

8. The system according to claim 6, additionally comprising:
a geolocalization system including known locations for at least one of a staircase, an elevator or an escalator within the multi-floor environment, the geolocalization system locating the mobile device within the multi-floor environment based on the known locations and activity labels including at least one of taking stairs, elevators or escalators.

9. The system according to claim 8, wherein the geolocalization system is adapted to reconstruct a trajectory for the mobile device within the multi-floor environment based on the activity label, the floor label and position estimates from the inertial measurement unit of the mobile device.

10. The system according to claim 6, additionally comprising:
a geolocalization system including pre-defined activities indicative of known locations within the multi-floor environment, the geolocalization system locating the mobile device within the multi-floor environment based on the known locations when the pre-defined activities are detected from the activity labels.

11. A computerized localization method comprising:
receiving, at an activity recognition module executing on a processor, inertial readings from an inertial measurement unit of a mobile device and pressure readings from a barometer; and
classifying, by the activity recognition module executing on the processor, activities for the mobile device from the inertial readings and the pressure readings.

12. The computerized method according to claim 11, wherein the inertial readings include acceleration readings from an accelerometer and gyroscopic readings from a gyroscope.

13. The computerized method according to claim 12, additionally comprising:
extracting, by a feature extractor of the activity recognition module, pose invariant features from the accelerometer and gyroscope readings; and
classifying the activities based on the pose invariant features.

14. The computerized method according to claim 13, wherein extracting the pose invariant features includes determining a vector of features from an autocorrelation matrix of the accelerometer and gyroscope readings.

15. The computerized method according to claim 13, additionally comprising:
extracting, by the feature extractor of the activity recognition module, statistical data from the pressure readings; and
classifying the activities based on the statistical data.

16. The computerized method according to claim 11, additionally comprising:
post-processing, by a post-processing module executing on the processor, the activity classifications from the activity recognition module and the pressure readings from the barometer in a Hidden Markov Model to determine an activity label and a floor label for the mobile device based on the activity classifications and the pressure readings.

17. A non-transitory, tangible computer-readable medium storing instructions adapted to be executed by at least one processor of a mobile device to perform a method comprising the steps of:
receiving, at an activity recognition module executing on the at least one processor, inertial readings from an inertial measurement unit of a mobile device and pressure readings from a barometer; and
classifying, by the activity recognition module executing on the at least one processor, activities for the mobile device from the inertial readings and the pressure readings.

18. The non-transitory, tangible computer-readable medium of claim 17, additionally storing instructions adapted to be executed by the at least one processor to perform the steps of:
extracting, by a feature extractor of the activity recognition module, pose invariant features from the inertial readings; and
classifying the activities based on the pose invariant features.

19. The non-transitory, tangible computer-readable medium of claim 18, additionally storing instructions adapted to be executed by the at least one processor to perform the step of:
extracting, by the feature extractor of the activity recognition module, statistical data from the pressure readings; and
classifying the activities based on the statistical data.

20. The non-transitory, tangible computer-readable medium of claim 17, additionally storing instructions adapted to be executed by the at least one processor to perform the step of:
post-processing, by a post-processing module executing on the at least one processor, the activity classifications from the activity recognition module and the pressure readings from the barometer in a Hidden Markov Model to determine an activity label and a floor label for the mobile device based on the activity classifications and the pressure readings.
